(19) United States
(12) Patent Application Publication
(10) Pub. No.: US 2011/0026392 A1
(43) Pub. Date: Feb. 3, 2011

(54) Method and Apparatus of Subcarrier Grouping for a Wireless Communication System

(76) Inventors: Chun-Hsien Wen, Hsinchu County (TW); Jiunn-Tsair Chen, Hsinchu County (TW); Cheng-Hsuan Wu, Taipei City (TW); Yung-Szu Tu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/637,733

(22) Filed: Dec. 14, 2009

(30) Foreign Application Priority Data
Jul. 29, 2009 (TW) 098125485

(51) Int. Cl. H04J 11/00; H04B 7/00; H04B 7/208

(52) U.S. Cl. 370/203; 370/310; 370/344

(57) ABSTRACT

A method sub-carrier grouping for a wireless communication system including a plurality of sub-carriers is disclosed. The method includes determining a coherent bandwidth of the plurality of sub-carriers, and dividing the plurality of sub-carriers into a plurality of sub-carrier groups according to the coherent bandwidth, wherein the size of each sub-carrier group is smaller than or equal to the coherent bandwidth.

### BACKGROUND OF THE INVENTION

1. Field of the Invention

The present invention relates to a sub-carrier grouping method and apparatus for a wireless communication system, and more particularly, to a sub-carrier grouping method and apparatus setting a size of each sub-carrier group smaller than or equal to a coherent bandwidth, to enhance correlation of sub-carriers within a sub-carrier group.

2. Description of the Prior Art

Orthogonal Frequency Division Multiple Access (OFDMA) technology is a multiple access technology based on Orthogonal Frequency Division Multiplexing (OFDM) technology, which provides more channels and services within the same spectrum. Therefore, many wireless communication systems, such as Worldwide Interoperability for Microwave Access (WiMAX), Long-Term Evolution (LTE), etc., have supported the OFDMA technology.

In detail, the OFDM technology is one of the Multi Carrier Modulation (MCM) transmission methods, with the principle of dividing a data stream with a higher transmission rate into several parallel streams with lower transmission rates, and utilizing these sub-streams to modulate different sub-carriers. In such a condition, a length of a symbol becomes longer, such that channel delay is comparatively small to the symbol length, so as to eliminate or reduce inter symbol interference, effectively enhance spectrum efficiency, and increase data throughput. The OFDM technology can be complemented with a variety of multiple access methods, such as Frequency Division Multiple Access (FDMA), Time Division Multiple Access (TDMA) and Code Division Multiple Access (CDMA), to expand the OFDM technology from a fixed access wireless system to a cellular mobile system.

OFDMA is an abbreviation of OFDM/FDMA, which further divides sub-carriers obtained from OFDM into several sub-carrier groups, or called sub-channels. Therefore, in the OFDMA system, a sub-channel is the minimum frequency resource unit when a base station assigns resources. Different sub-channels may be assigned to different users (or user groups), and a user can select a sub-channel with greater channel quality to perform data transmission.

In the prior art, a typical sub-channel includes consecutive sub-carriers within an operating frequency, and a size of the sub-channel, (i.e. a number of sub-carriers within the sub-channel) is fixed or randomly determined. For example, if the number of sub-carrier is 256, every 8 sub-carrier can be consecutively set as a sub-channel (i.e. a total of 32 sub-channels) in the prior art. Such method simply groups all sub-carriers according to predefined system rule without considering channel characteristics, transmission environment, etc., causing low transmission efficiency.

### SUMMARY OF THE INVENTION

It is therefore an objective of the present invention to provide a sub-carrier grouping method and device.

The present invention discloses a sub-carrier grouping method for a wireless communication system. The wireless communication system includes a plurality of sub-carrier. The sub-carrier grouping method includes determining a coherent bandwidth of the plurality of sub-carriers, and dividing the plurality of sub-carriers into a plurality of sub-carrier groups according to the coherent bandwidth. A size of each sub-carrier group is smaller than or equal to the coherent bandwidth.

The present invention further discloses a device for a wireless communication system, for executing the above sub-carrier grouping method, to divide a plurality of sub-carriers of the wireless communication system into a plurality of sub-carrier groups.

The present invention further discloses a transmission method for a wireless communication system, including detecting a plurality of sub-carriers of the wireless communication system, determining a coherent bandwidth of the plurality of sub-carriers, dividing the plurality of sub-carriers into a plurality of sub-carrier groups according to the coherent bandwidth, to have a size of each sub-carrier group smaller than or equal to the coherent bandwidth, and assigning a sub-carrier group of the plurality of sub-carrier groups to a user, for transmission data to the user.

The present invention further discloses a device for a wireless communication system, for executing the above transmission method, to transmit data to a user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a sub-carrier grouping process according to an embodiment of the present invention.

FIG. 2 is a schematic diagram of a sub-carrier grouping process according to another embodiment of the present invention.

### DETAILED DESCRIPTION

In the present invention, a sub-carrier grouping method for a wireless communication system determines a size of each sub-carrier group (i.e. a size of sub-channel) according to a coherent bandwidth. First, each frequency portion within a transmission channel suffers different attenuation magnitudes during a multipath transmission. When attenuation magnitudes over a range of frequencies have higher correlation, the range is defined as a coherent bandwidth. In other words, every frequency portion within the coherent bandwidth has the same (or similar) gain and linear phase shift. Therefore, for an OFDMA system, two sub-carriers within the coherent bandwidth suffer the same channel effect, such that characteristics of the two sub-carriers such as amplitude are highly correlated, and sub-carriers outside the coherent bandwidth suffer significantly different channel effects. In such a situation, the present invention sets a size of each sub-channel smaller than or equal to the coherent bandwidth, such that sub-carriers within a sub-channel suffer the same channel effect, for facilitating applications such as beamforming.

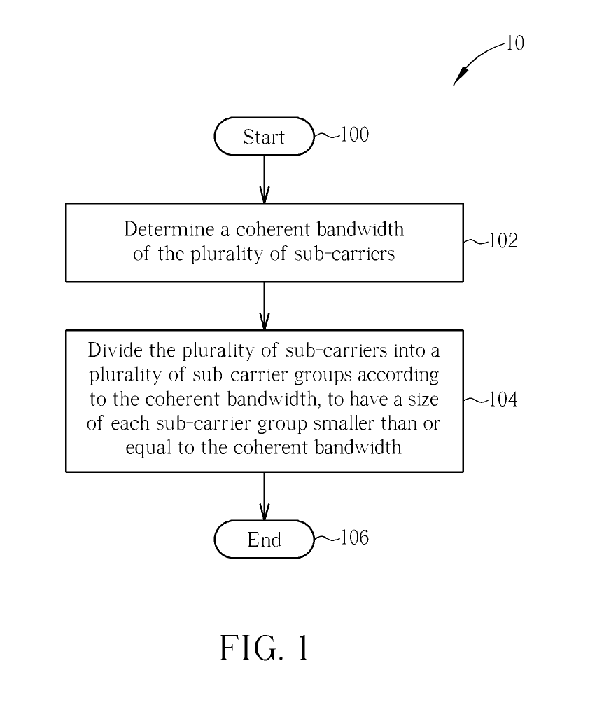

The above grouping method can be summarized into a sub-carrier grouping process 10, as shown in FIG. 1. The sub-carrier grouping process 10 performs grouping over a plurality of sub-carrier in a wireless communication system, and includes the following steps:
Step 100: Start.
Step 102: Determine a coherent bandwidth of the plurality of sub-carriers.
Step 104: Divide the plurality of sub-carriers into a plurality of sub-carrier groups according to the coherent bandwidth, to have a size of each sub-carrier group smaller than or equal to the coherent bandwidth.
Step 106: End.

Through the sub-carrier grouping process 10, the present invention first determines a coherent bandwidth, and then divides a plurality of sub-carriers into a plurality of sub-carrier groups, whereby a size of each sub-carrier group is smaller than or equal to the coherent bandwidth. As a result, sub-carriers within a same sub-carrier group suffer the same channel effect, such that the system can correctly determine a condition or a state of each sub-carrier group, for effectively assigning resource.

In a word, the present invention sets the size of each sub-carrier group (i.e. the size of sub-channel) smaller than or equal to the coherent bandwidth, such that sub-carriers within a sub-channel have higher correlation. Noticeably, methods for defining or determining a coherent bandwidth shall be known by those skilled in the art, which are not limited to specific processes or steps, and can be illustrated as follows.

As can be seen from the above, in the OFDMA system, the sub-carriers within the coherent bandwidth have higher correlation. Thus, a cross-correlation function corresponding to a sub-carrier interval can be calculated, which can be expressed as the following equation:

$$C = {\sum }_{k} \frac{h ( k )}{\vert h ( k ) \vert} \times \frac{{h}^{*} ( k + D )}{\vert {h}^{*} ( k + D ) \vert} , \qquad ( Eq . 1 )$$

where C denotes the cross-correlation function, h(k) denotes a k-th sub-carrier of the plurality of sub-carriers arranged according to a descending frequency order, D denotes the interval, and * denotes conjugate complex.

The sub-carrier interval D is a preset integer. After the sub-carrier interval D is set, the cross-correlation function C can be calculated. Then, the cross-correlation function C is compared with a default threshold TH. If the cross-correlation function C is smaller than the threshold TH, which means correlations between sub-carriers are smaller than a default value in the set sub-carrier interval D, the sub-carrier interval D shall be reset. Otherwise, if the cross-correlation function C is greater or equal to the threshold TH, which means correlations between sub-carriers are greater than the default value in the set sub-carrier interval D. In other words, sub-carriers within a range of the sub-carrier interval D are within the coherent bandwidth. Accordingly, the coherent bandwidth can be determined by the following equation:

BW_{—}CR≧BW_{—}SCR×D, (Eq.2)

where BW_CR denotes the coherent bandwidth, and BW_SCR denotes a sub-carrier bandwidth.

Since the size of a sub-carrier group (the size of a sub-channel) is set smaller than or equal to the coherent bandwidth according to the present invention, the size of a sub-channel can be set as a product of the sub-carrier bandwidth BW_SCR and the sub-carrier interval D according to Eq.2, to meet requirement of the present invention:

BW_{—}SCH=BW_{—}SCR×D, (Eq.3)

where BW_SCH denotes the size of a sub-channel.

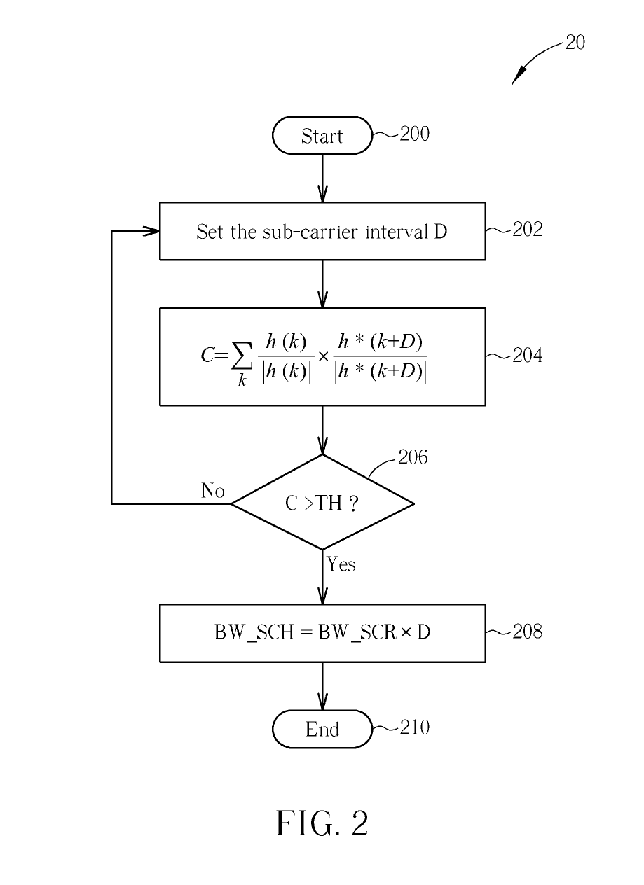

By the above operation method, a sub-carrier grouping process 20 can be derived from the sub-carrier grouping process 10, as shown in FIG. 2. The sub-carrier grouping process 20 includes the following steps:
Step 200: Start.
Step 202: Set the sub-carrier interval D.
Step 204: Calculate

$$C = {\sum }_{k} \frac{h ( k )}{\vert h ( k ) \vert} \times \frac{{h}^{*} ( k + D )}{\vert {h}^{*} ( k + D ) \vert} .$$

Step 206: Determine whether C is greater than the threshold TH. If yes, perform step 208, otherwise, go to step 202, to reset the sub-carrier interval D.
Step 208: Set the size of a sub-channel BW_SCH as the product of the sub-carrier bandwidth BW_SCR and the sub-carrier interval D.
Step 210: End.

Therefore, through the sub-carrier grouping process 20, the size of a sub-channel BW_SCH would be smaller than the coherent bandwidth, such that sub-carriers within the same sub-channel have higher correlation. The system can correctly determine a condition or a state of each sub-channel, for effectively assigning wireless resource.

Noticeably, the sub-carrier grouping process 10 or 20 is utilized in the OFDMA system to determine the size of a sub-carrier group, in practical, which can be realized by software, firmware, hardware, etc., to divide sub-carriers into groups with a proper size.

In the prior art, the system randomly determines or fixes the size of a sub-channel without considering properties such as channel characteristics, transmission environment, etc. In comparison, the present invention considers sub-carrier characteristics and sets the sub-channel bandwidth smaller than or equal to the coherent bandwidth. Thus, the sub-carriers within the same sub-channel suffer the same channel effect, such that the system can correctly determine a condition or a state of each sub-channel, for effectively assigning resource while facilitating applications such as beamforming.

On the other hand, the OFDMA technology has been utilized in many wireless communication systems. Therefore, realization of the sub-carrier grouping processes in the present invention should properly adjust operation methods according to system requirement of the corresponding wireless communication system. For example, in a wireless communication system conforming to IEEE 802.11 standard, a base station should perform channel estimation first, to determine a state and a coherent bandwidth of a sub-carrier. Then, all sub-carriers are divided into a plurality of sub-carrier groups according to coherent bandwidth. Each sub-carrier group is a sub-channel, and a size of a sub-carrier group (the number of sub-carriers within a sub-channel) should be smaller than or equal to the coherent bandwidth. Finally, the base station takes a sub-channel as a unit to assign transmission resource. In this case, the complexity for the base station to perform resource assigning is significantly reduced. For example, if the number of sub-carriers is 256 and the coherent bandwidth is 16 sub-carrier bandwidths, the number of sub-carriers within a sub-channel is 16. Therefore, instead of assigning resource to 256 sub-carriers, the present invention only needs to assign resource to 16 sub-channels. More importantly, since the present invention performs sub-carrier grouping according to the coherent bandwidth, such that sub-carriers within the same sub-channel suffer similar channel effects, the base station can estimate transmission conditions of each sub-channel, so as to assign a proper sub-channel according to user (or user group) requirement.

To sum up, the present invention sets the size of a sub-carrier group (i.e. the size of a sub-channel) smaller than or equal to the coherent bandwidth, such that sub-carriers within a sub-carrier group have higher correlation.

Those skilled in the art will readily observe that numerous modifications and alterations of the device and method may be made while retaining the teachings of the invention.

What is claimed is:

1. A sub-carrier grouping method for a wireless communication system, the wireless communication system comprising a plurality of sub-carriers, the sub-carrier grouping method comprising:
determining a coherent bandwidth of the plurality of sub-carriers; and
dividing the plurality of sub-carriers into a plurality of sub-carrier groups according to the coherent bandwidth, such that a size of each sub-carrier group being smaller than or equal to the coherent bandwidth.

2. The sub-carrier grouping method of claim 1, wherein the step of determining the coherent bandwidth of the plurality of sub-carriers comprises:
setting an interval;
calculating a cross-correlation function of the plurality of sub-carriers corresponding to the interval; and
comparing the cross-correlation function with a threshold, for determining the coherent bandwidth.

3. The sub-carrier grouping method of claim 2, wherein the step of calculating the cross-correlation function of the plurality of sub-carriers corresponding to the interval is calculating an equation, which is expressed as:
$$C = {\sum }_{k} \frac{h ( k )}{\vert h ( k ) \vert} \times \frac{{h}^{*} ( k + D )}{\vert {h}^{*} ( k + D ) \vert} ;$$
wherein C denotes the cross-correlation function, h(k) denotes a k-th sub-carrier of the plurality of sub-carriers arranged according to a descending frequency order, D denotes the interval, and * denotes conjugate complex.

4. The sub-carrier grouping method of claim 2, wherein the step of comparing the cross-correlation function with the threshold for determining the coherent bandwidth comprises determining that the coherent bandwidth is greater than a product of the interval and a sub-carrier bandwidth of the plurality of sub-carriers when the cross-correlation function is greater than the threshold.

5. The sub-carrier grouping method of claim 1, wherein the wireless communication system applies an orthogonal frequency division multiple access technology.

6. A device for a wireless communication system, for executing the sub-carrier grouping method of claim 1, to divide a plurality of sub-carriers of the wireless communication system into a plurality of sub-carrier groups.

7. A transmission method for a wireless communication system, comprising:
detecting a plurality of sub-carriers of the wireless communication;
determining a coherent bandwidth of the plurality of sub-carriers;
dividing the plurality of sub-carriers into a plurality of sub-carrier groups according to the coherent bandwidth, to have a size of each sub-carrier group smaller than or equal to the coherent bandwidth; and
assigning a sub-carrier group of the plurality of sub-carrier groups to a user, for transmitting data to the user.

8. The transmission method of claim 7, wherein the step of determining the coherent bandwidth of the plurality of sub-carriers comprises:
setting an interval;
calculating a cross-correlation function of the plurality of sub-carriers corresponding to the interval; and
comparing the cross-correlation function with a threshold, for determining the coherent bandwidth.

9. The transmission method of claim 8, wherein the step of calculating the cross-correlation function of the plurality of sub-carriers corresponding to the interval is calculating an equation, which is expressed as:
$$C = {\sum }_{k} \frac{h ( k )}{\vert h ( k ) \vert} \times \frac{{h}^{*} ( k + D )}{\vert {h}^{*} ( k + D ) \vert} ;$$
wherein C denotes the cross-correlation function, h(k) denotes a k-th sub-carrier of the plurality of sub-carriers arranged according to a descending frequency order, D denotes the interval, and * denotes conjugate complex.

10. The transmission method of claim 8, wherein the step of comparing the cross-correlation function with the threshold for determining the coherent bandwidth comprises determining that the coherent bandwidth is greater than a product of the interval and a sub-carrier bandwidth of the plurality of sub-carriers when the cross-correlation function is greater than the threshold.

11. The transmission method of claim 7, wherein the wireless communication system applies an orthogonal frequency division multiple access technology.

12. A device for a wireless communication system, for executing the transmission method of claim 7, to transmit data to a user.
